(19) United States
(12) Patent Application Publication
(10) Pub. No.: US 2018/0275756 A1
(43) Pub. Date: Sep. 27, 2018

(54) System And Method Of Controlling Based On A Button Having Multiple Layers Of Pressure

(71) Applicant: CISCO TECHNOLOGY, INC., San Jose, CA (US)

(72) Inventors: Pete Rai, Surrey (GB); Stephen Tallamy, Berkshire (GB); Patricia Patitucci, Woking (GB)

(21) Appl. No.: 15/465,714

(22) Filed: Mar. 22, 2017

(51) Int. Cl. G06F 3/01; G06F 3/0488; G06F 3/0489

(52) U.S. Cl. CPC G06F 3/016; G06F 3/0489; G06F 3/04886

(57) ABSTRACT

A device and method for providing multiple functions in a context based on a level of pressure the user provides on a button. The method includes receiving first user input from a user, at a first level of pressure, via a button on a device, the first user input resulting in a first function being performed, providing, based on the first user input and based on a context associated with the first user input, a first indication of a second function that would be performed if the user provided a second user input at a second level of pressure on the button. The method further includes receiving the second user input at the second level of pressure on the button and, based on receiving the second user input, performing the second function and presenting a second indication that the second function has been performed. Additional levels of pressure and feedback may apply dependent on the context.

### BACKGROUND OF THE INVENTION

### Field of the Invention

This application relates to use of remote control buttons having various pressure levels for controlling media.

### Description of the Related Art

The present disclosure relates to pressure based touch screens and buttons. The use of these buttons and screens is generally known. Such a button or screen can register not just the presence of a touch in a binary way but also the pressure that is being applied as well.

Using a button or a touchscreen to control media is a complicated process and includes a great deal of options. As the technical capability in rendering of media and the various possibilities for control increases, the number of options and choices for the user to make also increases. Having a large number of options can lead to more complexity in enabling the user to navigate to a desired option and make the selection.

### BRIEF DESCRIPTION OF THE DRAWINGS

These and other sample aspects of the present technology will be described in the detailed description and the appended claims that follow, and in the accompanying drawings, wherein:

FIG. 1 illustrates a block diagram of an example system embodiment;

FIG. 2 illustrates various representations of different levels of pressure on a screen or button;

FIG. 3 illustrates an example use of a pressure sensitive button for pagination purposes;

FIG. 4 illustrates an example of using a pressure sensitive button for changing channels; and

FIG. 5 illustrates the use of a pressure sensitive button for volume control;

FIG. 6 illustrates the use of a pressure sensitive button for trick play of media;

FIG. 7 illustrates the use of a pressure sensitive button for recording; and

FIG. 8 illustrates a method embodiment of the disclosure.

### BRIEF INTRODUCTION

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later. In accordance with one or more aspects of the examples described herein, systems and methods are provided which enable multiple functions to be accessible to be performed based on a level of pressure that a user provides to a button. The approach can simplify a user interface and enhance the ability to navigate and select particular functions, a canonical example being the viewing of media.

The following disclosure relates to systems, methods, and computer readable media storing instructions for providing multiple functions in a context based on a level of pressure the user provides on a button. An example of the context might be a user who desires to change television channels, for viewing media, controlling volume, recording a program or a series of programs, and so forth. The method includes receiving first user input from a user, at a first level of pressure, via a button on a device, the first user input resulting in a first function being performed, providing, based on the first user input and based on the context associated with the first user input, a first indication of a second function that would be performed if the user provided a second user input at a second level of pressure on the button. The method further includes receiving the second user input at the second level of pressure on the button and, based on receiving the second user input, performing the second function and presenting a second indication that the second function has been performed.

A simple example of the concept in action could be where the user is using a button on a remote to change channels. After the user changes channel several times, the system presents indication that if the user presses the button a bit harder, they can change channels based on genre rather than simple channel number. The user then presses the button a bit harder as instructed and is now jumping to news stations, movie stations, documentary stations, and so forth. Thus, the functionality achieved through pressing the button changed depending on the pressure level applied. This additional level of control saves the user time by avoiding the need to navigate menus of the user interface or locate an alternative button.

### DETAILED DESCRIPTION

The subject disclosure provides techniques for tracking usage of distributed software for virtual machines, in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

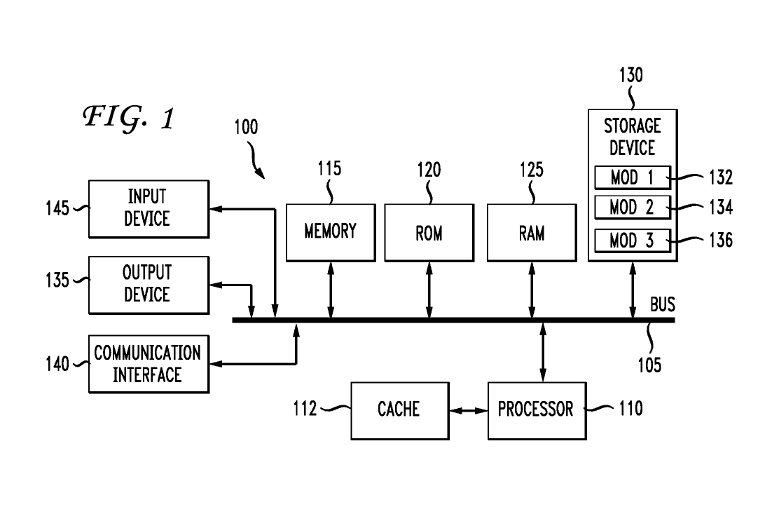

The disclosure next turns to FIG. 1 which generally describes a computer system, such as a computer client or server. FIG. 1 illustrates a computing system architecture 100 wherein the components of the system are in electrical communication with each other using a bus 105. Exemplary system 100 includes a processing unit (CPU or processor) 110 and a system bus 105 that couples various system components including the system memory 115, such as read only memory (ROM) 120 and random access memory (RAM) 125, to the processor 110. The system 100 can include a cache of high-speed memory connected directly with, in close proximity to, or integrated as part of the processor 110. The system 100 can copy data from the memory 115 and/or the storage device 130 to the cache 112 for quick access by the processor 110. In this way, the cache can provide a performance boost that avoids processor 110 delays while waiting for data. These and other modules can control or be configured to control the processor 110 to perform various actions. Other system memory 115 may be available for use as well. The memory 115 can include multiple different types of memory with different performance characteristics. The processor 110 can include any general purpose processor and a hardware module or software module, such as module 1 132, module 2 134, and module 3 136 stored in storage device 130, configured to control the processor 110 as well as a special-purpose processor where software instructions are incorporated into the actual processor design. The processor 110 may essentially be a completely self-contained computing system, containing multiple cores or processors, a bus, memory controller, cache, etc. A multi-core processor may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech and so forth. An output device 135 can also be one or more of a number of output mechanisms known to those of skill in the art. In some instances, multimodal systems can enable a user to provide multiple types of input to communicate with the computing device 100. The communications interface 140 can generally govern and manage the user input and system output. There is no restriction on operating on any particular hardware arrangement and therefore the basic features here may easily be substituted for improved hardware or firmware arrangements as they are developed.

Storage device 130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules are contemplated. The storage device 130 can be connected to the system bus 105. In one aspect, a hardware module that performs a particular function can include the software component stored in a computer-readable medium in connection with the necessary hardware components, such as the processor 110, bus 105, display 135, and so forth, to carry out the function.

The present disclosure relates to improved structures and methods for using a pressure sensitive button or screen to control media. The principles set forth herein can also be used to control any functionality, device, vehicle, remote control cars, appliances, security systems, and so forth. Most of the disclosure will relate to a particular features relating to media, but where applicable, the principles can apply to any control operation.

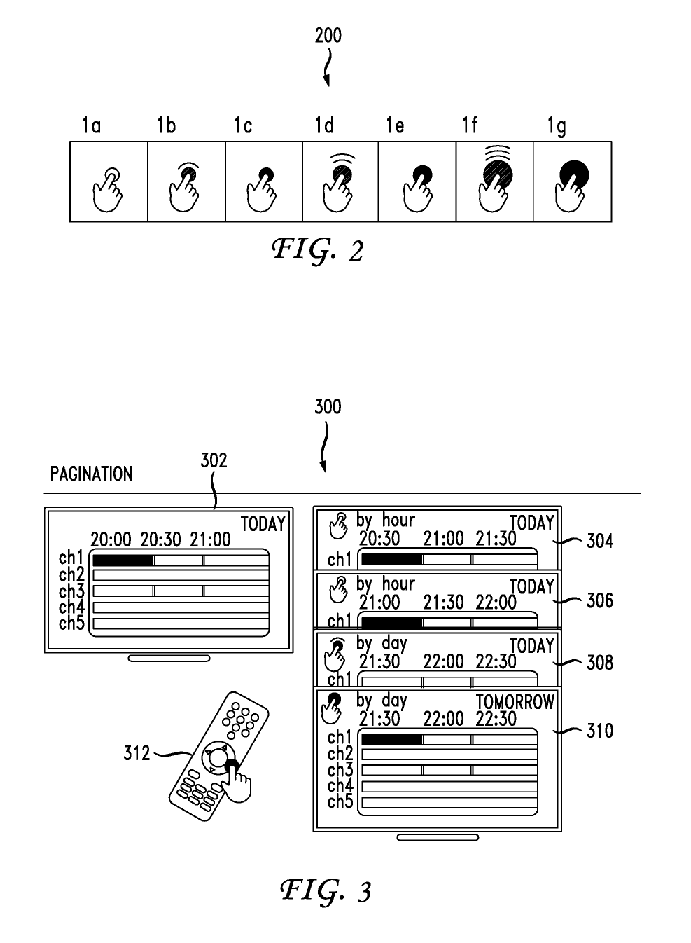

In one aspect, as shown in FIG. 2, a remote control device, which can include a physical button or a touchscreen, will have various levels of pressure which can be applied to perform different functions. As shown in FIG. 2, assume that each graphical representation instructs a user to provide a different level of pressure. For example, icon 1a represents and shows the user that a normal press is currently occurring. Thus, as a user is pressing a button or a screen, a graphical interface can present an icon similar to one which represents a “normal” press is being performed or received. The graphical representation can be on the remote control device itself or on a separate screen. For example, if a user has a satellite remote and is watching a satellite program on a wall-mounted TV, the graphical element can be presented on the wall-mounted TV while the button press is experienced by the remote control. The concepts disclosed herein cover both remote control units, devices, as well as the actions of controlling any action, function, device and so forth remotely.

Icon 1b of FIG. 2 can inform the user of what action will happen if the user instigates a deeper press of the button. Various levels will be discussed, and assume for the moment that icon 1b represents a “level 1” amount of pressure. A color of the icon can also represent a correlation to the level of pressure. The icon 1b can be presented not representing the amount of pressure that the user is currently providing but what will happen if the user pushes a little bit deeper. In this sense, aspects such as a color, or the wavy line above the circle being pressed can indicate a “call to arms” for a future action. In one aspect, the deeper press button is shown as having a larger circumference as well. Icon 1c provides an example icon that instructs the user that the deeper action indicated as a choice in icon 1b has been realized.

Icon 1d can inform the user of what action will happen if the user initiates a deeper still press and reaches a “level 2” in the current context. In this case, assume that the icon is blue and now there are two wavy lines that indicate a “call to arms” for a future action. The circumference of the circle also has is larger than the previous icon 1c circumference. Icon 1e can be presented to inform the user that the deeper action indicated as a choice in icon 1d has now been realized. Icon 1f again can inform the user of what action will happen if the user instigates a still deeper press and reaches a “level 3” level of pressure in the current context. Again, assume the color of the icon is blue and that there are three wavy lines indicating a “call to arms” for a future action. The circumference of the press button also is larger than the previous circumference in icon 1e. Finally, icon 1g illustrates a graphical presentation that can tell the user the deeper action indicated as a choice in icon 1f has been realized.

The above icons represent an example of the type of feedback that can be presented to a user which both can indicate a current level of pressure that the user's finger is exhibiting on a button or screen, as well as future functions that will be presented if the user pushes deeper into a new level. Of course, circles are provided with, in some cases, wavy lines above the circle that indicate future actions which will occur. Any shape, color, or other indication can be considered as within the scope of this disclosure. Thus, they icons could be squares, triangles, three-dimensional objects, different colors, animal shapes, and so forth. The more general concept is that the system presents one or more features of an indicator of a normal press pressure, and/or an indicator of a future action that can occur if a different level of pressure is provided, and/or an indicator that a choice or a functionality has been realized based on a button press at an appropriate pressure.

It is further noted that a multimodal approach can also be provided in this context. Thus, in one example, icons 1a, 1c, 1e and 1g could be graphically provided to illustrate the realization of particular actions, and icons 1b, 1d, and 1f could be replaced with audible signals such as one beep, two beeps, and three beeps representing what would happen if the user presses down to level 1, level 2, or level 3. The number of levels of course is variable and it is presumed that the present system includes at least a normal press level and one “deeper” level of pressure.

In another aspect, inasmuch as part of this disclosure is the concept of having multiple levels of pressure that can be utilized to select different functionality, the button, or the touchscreen, can also provide tactile feedback regarding what level the user has pressed to. For example, a click may be felt and/or heard each time the user presses hard enough to reach a new level. A different tactile feedback may be provided depending on if the user has pressed hard enough to reach a level 1, level 2 or level 3. In one aspect, a remote control can also be provided with an adjustable button or screen such that depending on the application used, the device used to receive the button press adjusts. For example, if the user is using a remote control for controlling media, and it is desirable to have three different levels of pressure deeper than a normal level of pressure, then the remote control will provide that type of feedback such that the user can detect, at a certain level of pressure, that they have gone into level 2 control. Then, if the user changes to an application in which they are writing in a Microsoft Word document, or controlling a remote control car, and that application or context would only require the normal press level and one deeper level, then the button on the device can adjust such that any tactile feedback would only recognize a normal level of pressure and one deeper level of pressure. Of course the number of different layers can be 2, 3, 4, 5, or any number of different layers of functionality that are accessed or triggered based on pressure.

Next, FIG. 3 illustrates an example 300 of the semantics according to this disclosure for scrolling through channels in an electronic programming guide. Assume that the user is pressing a button that scrolls time by the hour. A remote control 312 is used to control the electronic programming guide. A general screen 302 is shown with the different channels and the times for programs today. In screen 304, the icon in the upper left indicates an icon similar to icon 1a of FIG. 2 which instructs the user that they are providing a normal press and that the functionality is scrolling time by the hour. Assume that the user continues to provide the normal press level in remote 312 and that screen 306 maintains the same icon and functionality of scrolling by the hour.

Next, assume that the user has scrolled for a predetermined period of time, or for amount of time or a number of clicks that is met a threshold, such that screen 308 presents an icon similar to icon 1b in FIG. 2 which now provides an instruction to the user on the interface 306 that if they instigate a deeper press to level 1 in the current context, a new functionality will occur. Here, the graphic is accompanied by the words “by day” which instructs the user that if they press down with a level 1 amount of pressure, the pagination will occur by the day (rather than by the hour, as they previous were doing). Interface 310 illustrates a graphic in the upper left-hand corner which is changed indicating that the deeper action indicated has been realized and note the upper right-hand corner the word “tomorrow” indicating that they are now searching by the day rather than by the hour. Of course, additional variations could be included, such as searching by the week, by the month, year, and so forth. The location, size, shape, color, or other configuration can vary based on the circumstances.

There can be any number of ways in which the functionality of pressing the button can be changed or triggered, or the circumstances under which a notice is presented. For example, a speed at which the user presses the button under a normal level of pressure can cause an indicator to be presented of how they can change the functionality with a different level of pressure. For example, in FIG. 3, if the user presses the button with a normal level of pressure once every second or three seconds, that rate of button pressing could trigger the indicator instructing the user about a different level of pressure that can be made to change the functionality. In one example, if the user is pressing the button once every second, the system may analyze that level of input and determine to present an indicator that if the user presses to a second level of pressure, the user can search by the week. However, if the rate of button pressing is once every three seconds, then the analysis could include determining that they may desire to search by the day, and present the indicators shown in FIG. 3. In another aspect, the user can provide some kind of specific input which causes the system to respond with an indicator of a different level of pressure for different functionality. For example, if the user presses and holds the button, such input could be a trigger which could bring up one or more icons instructing the user of the options available for different levels of pressure.

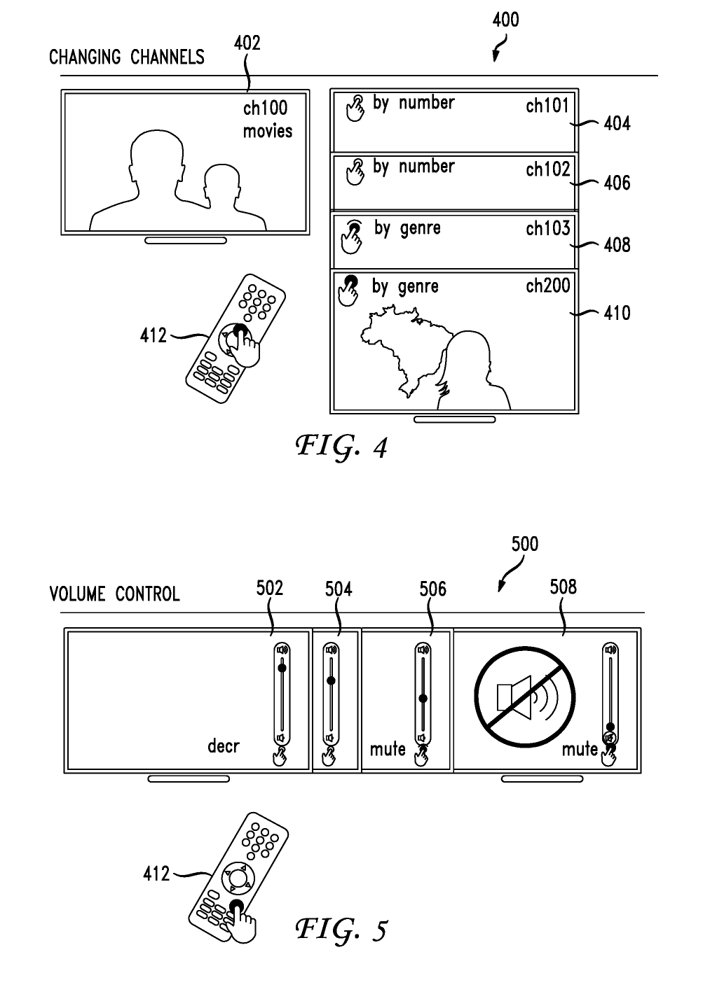

Next, this disclosure provides an example of the semantics the can be used in the context of this disclosure to process a channel change. FIG. 4 illustrates various interfaces 400 for changing channels using the remote 312. Interface 402 shows a general device for watching movies or TV. In this example, a normal pressure pressing of the button on remote 312 will scroll the channels by number as is shown in screens 404, 406. In screen 408, an icon is presented that indicates that the deeper press will scroll by genre. An interface 410, the user has pressed deeper and the icon indicates a realization of that deeper press and, as is shown in the upper right-hand corner of interface 410, the channel is changed from channel 103 to channel 200 and the genre is “news.” At this stage, the user could keep pressing at that next level of pressure to jump to the next genre or lessen the pressure to go back to channel scrolling. This functionality also enables the user to choose a genre like the news and then go back to channel scrolling at a normal level of pressure but in that scenario, the channel scrolling is just within the news channels. Thus, with one button, additional functionality and navigation becomes possible.

FIG. 5 illustrates interfaces 500 for controlling the volume. In interface 502, the user is pressing the button at the normal level of pressure which is simply controlling the level of volume to go up or down. Interface 504 shows the volume on its way down based on the user's pressing of the button. Interface 506 illustrates the icon hint that indicates that a deeper press will jump straight to mute. Interface 508 represents the realization of that deeper press with the volume on mute. Thus, rather than requiring the user to press a separate button, or continue to press or hold the button at a normal level of pressure for the volume to eventually become completely quiet, the use of the deeper press can lead the user to a quicker result.

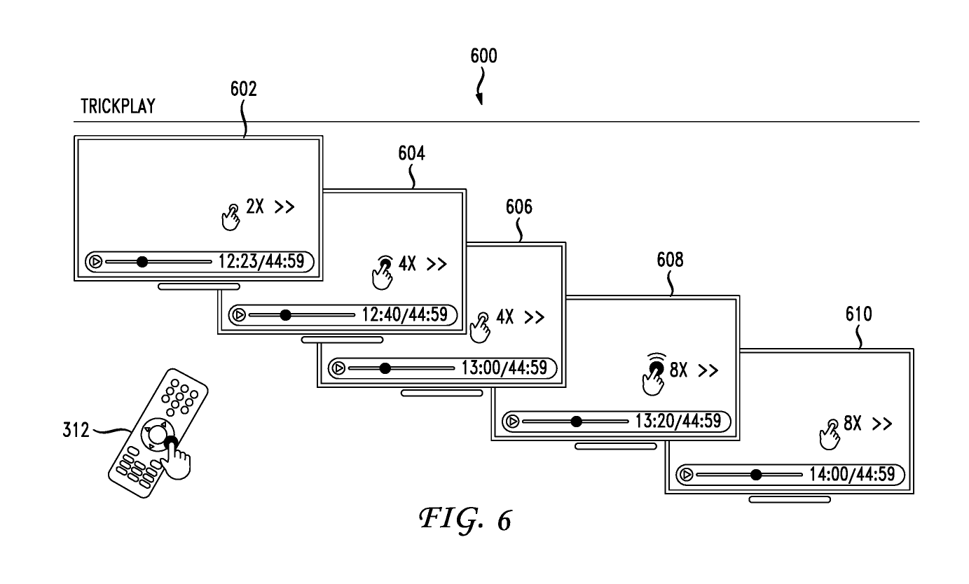

FIG. 6 illustrates a set of interfaces 600 which illustrates a trick play approach using the remote 312. Interface 602 represents the user pressing the button in order to fast-forward a media presentation. As is shown, pressing the button at a normal level of pressure causes a 2× speed of the presentation of the media. Interface 604 provides an indicator that a deeper press will cause the media to play at 4× the normal speed. Interface 606 represents the realization of that deeper pressure such that the media is being played at 4× the normal speed. Additionally, interface 608 shows an indication of an even faster play in which a level 2 amount of pressure would lead to a playback speed of 8× the normal speed. Interface 610 illustrates the realization of the 8× speed of playback as the user had provided the deeper level of pressure.

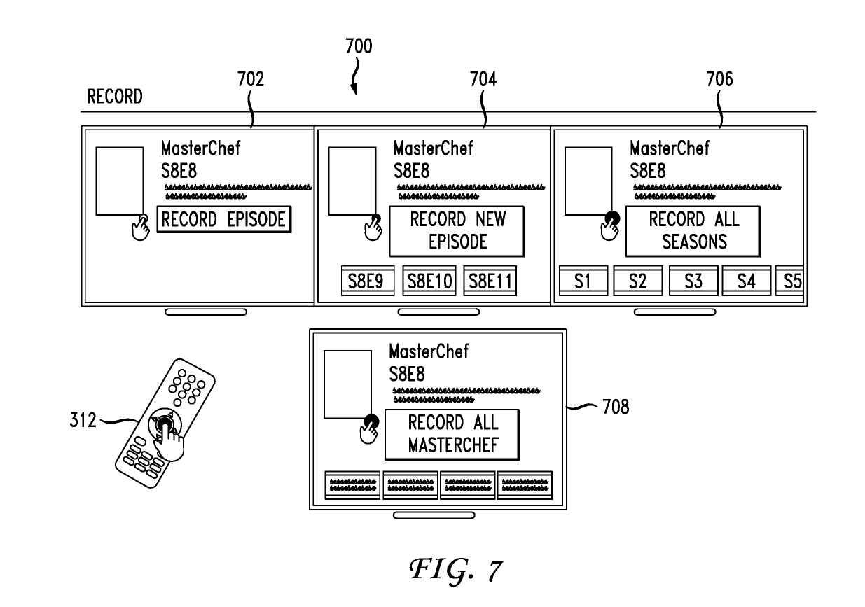

FIG. 7 illustrates a series of interfaces 700 that illustrate the application of the concepts disclosed herein to recording. Interface 702 represents the user providing a normal level of pressure to record the MasterChef® program. Assume that an interface is provided, which is not shown, which instructs the user that pressing to a level 1 level of pressure would result in the function of recording all new episodes in a season. The result of pressing at a pressure of level 1 is shown in interface 704. Of course the functionality at this level could also be varied such that the recording is of all future episodes, all episodes in the season not previously seen by the user, or simply all the episodes in a single season. Next, assume again that an indicator could be presented to the user that pressing at a level 2 level of pressure would result in recording all seasons of MasterChef®. The result of pressing at level 2 is shown in interface 706. Next, an even deeper level of press could result in the functionality of recording all associated material as well which can include commentary, bloopers, metadata, and so forth. The result of such a level 3 pressure button press is shown in interface 708. This of course could also apply to downloading a particular program and any or all of the controls associated with such an action.

The present disclosure provides a consistent user experience which can be used to simplify complex user interactions by making use of pressure aware buttons. A different experience can be applied to different situations and different scenarios, but can always work in a way that is consistent and expected within the context in which it is being used. The overall idea is that deeper presses of the button imply a deeper action or a different action in a current context. On-screen visible graphics can guide the user with respect to what functionality is available with a deeper press and confirmation of the realization of that functionality. Several advantages of this approach include simplifying the on-screen layout and reducing the number of options that the user needs to navigate on a remote control. In one aspect, the system only shows a representation or an indicator of what happens with a deeper action when the user has already committed to a contextual shallower option. Thus, when the user is already within a context for the action, then the system will provide instructions or indications of what can happen when a deeper action is pressed. This approach removes clutter from the screen. Clutter can also be reduced from a remote control unit while maintaining the simplicity of remote control interaction. In some scenarios, remote controls also utilize very few buttons and providing additional functionality as is disclosed herein can enhance the user experience where a remote already is limited to only a few buttons. In one aspect, the concepts disclosed herein provide an intuitive interaction between a pressure sensitive control device and an independent display device. Thus, the present disclosure, in one aspect, decouples the feedback onto a second display device, such as a TV. Often, in a media viewing scenario, the remote control device is not something that the user is looking at while they are pressing the button. Users were typically be looking up at a television rather than looking at the remote control when performing the changing of channels, changing volume, and so forth.

In another scenario, such as an iPhone, Samsung Galaxy, or other handheld device with a touch sensitive screen, the principles disclosed herein could be applicable to those scenarios as well. For example, there is an ongoing problem of typing on such small devices. In one example related to keyboard usage, the QWERTY keyboard presented on the device can be difficult for users to manage. The user will try to type the letter “k” and will actually type the letter “l” on accident, thus causing a word to be misspelled. In some scenarios, feedback could be provided on a handheld screen which could indicate that the user is pressing at a normal level of pressure and the result of the press is likely to be the “l” key. However, based on the location of the pressure, the system could determine that there is a relatively high probability that the user desires the “k” letter. In this scenario, the system can provide some feedback indicating that if the user provides a deeper press, the result will be a “k”. In a specific example, some user interfaces will pop up an indicator of the key that is being pressed. Thus, while the user is pressing on the “k” key, a “k” will pop up from underneath the user press to tell the user that the system is interpreting that input as the “k” key. However, the location of the pressure could suggest that the user does desire the “l” letter instead. In that scenario, rather than popping up just an indication of the letter “k”, the system could also add a suggestion that a deeper press would result in the “l” letter.

In another scenario related to the use of keyboards on a smaller device, a level 1 press could always cause the letter to the left to be chosen, and a level 2 press could cause the letter to the right to be chosen. Further, on keyboards on mobile devices, there are different layers of functionality, such as a layer for numbers and symbols, a layer for emoticons, and so forth. Thus, in another example, the system could present an interface which illustrates not only that the user is pressing the “k” button but that if the user did a level 1 press, they could get a “K” (capital “k”), in that a level 2 press they could get “?” (a question mark) and at a level 3 press they could get a “ [symbol] ” (smiley face icon). Thus, the amount of pressure that is provided could enable the user to step through the different pages of functionality on a keyboard.

In yet another example, s button press on a music playback device could apply the principles disclosed herein. For example, a user could be scrolling through songs alphabetically by title. A button could be used to cycle through the songs. An indicator as disclosed herein could be presented giving the user instructions that a deeper press could result in the function of skipping the next starting letter for a title, or searching by songwriter, or tune style, or genre, or any other category. Thus, any additional functionality that can be applied to managing the selection of music including an individual song or an entire album or theme could be controlled of the principles disclosed herein.

As can be appreciated, the general concepts disclosed herein can be applied in many different scenarios and any context or control the can be performed by a button, and which also has alternate functions which could be performed, can utilize the principles disclosed herein.

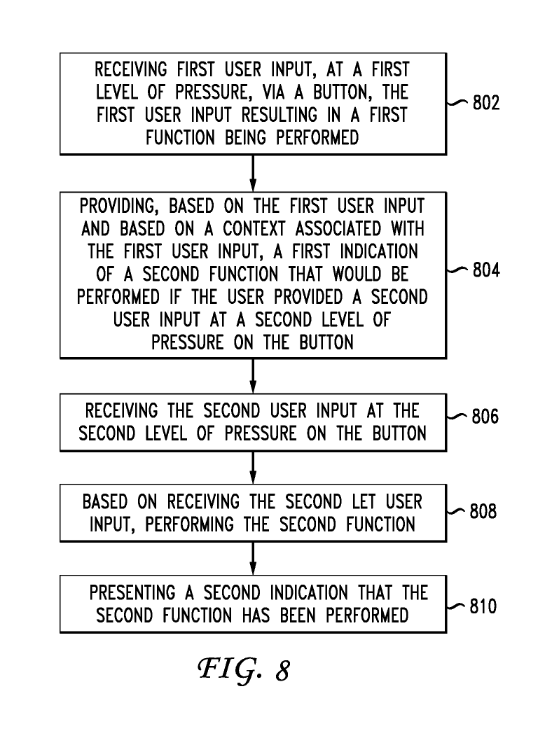

FIG. 8 illustrates a method aspect of this disclosure. The method includes receiving first user input, at a first level of pressure, via a button, the first user input resulting in a first function being performed (802), providing, based on the first user input and based on a context associated with the first user input, a first indication of a second function that would be performed if the user provided a second user input at a second level of pressure on the button (804), receiving the second user input at the second level of pressure on the button (806), based on receiving the second let user input, performing the second function (808) and presenting a second indication that the second function has been performed (810).

In one aspect, the second level of pressure is greater than the first level of pressure. However, the relative levels of pressure could also vary. For example, the user may initially be pressing the button very hard. The additional functionality may occur if the user actually provides less pressure in later interactions. The system may also adjust the functionality based on user history, or user experience, or user preferences. For example, if the system knows that John is using the remote control, and John typically presses the button very hard, the system may adjust such that a “normal” level of pressure for the first functionality or John would objectively be characterized as a level 3 level of pressure for the average person. Then, the indicators could provide that to achieve the other functionality, John needs to press less on the button to change to day by day or week by week channel surfing. The system can identify in any manner the particular individual that is using a remote control unit. There are many known technologies such as fingerprint recognition, voice recognition, and so forth that could be applied to identify the user of the remote control unit or device.

The method of course can include, based on the second function being performed, presenting a third indication that third function would be performed if the user provided a third user input at a third level of pressure on the button. Depending on the number of levels of pressure and functionality, the system could continue in this manner. The indication might start out very obvious while “training” the user and then become more subtle once user has experience with the interaction. Knowing whether the user is a beginner or not can be based on a user logging into a computer system and tracking whether that user has received indicators about different functionalities for different levels of pressure. Other indicators could include testing and evaluating how a user utilizes a button to determine whether they are accessing additional functionality through appropriate levels of pressure on the button. Based on this feedback and understanding, the indications can be adjusted for a newer user or a more experienced user as needed.

The context above can include one or more contexts such as changing channels, pagination, volume control, recording functionality, or trick play. The indications set forth above can be one or more of visual, color based, audible, multimodal, tactile, vibration based, time-based, image-based, and so forth.

The concept of providing, based on the first user input and based on a context associated with the first user input, an indication of additional functionality, can be based on an analysis of the first user input. For example, a timing of how quickly the user presses the button on a periodic basis can guide the choice of the second functionality such as whether to change channels based on genre, movies, and so forth. The user may hold the button down for a longer period of time which can be interpreted also as an indication of a certain type of additional functionality achievable through deeper button presses. The user may also provide additional input such as audible input which can be received and interpreted to control the additional available functionality through deeper button presses. Any other input could also be provided. For example, some mobile devices have location-based capability, gyroscopes, motion sensing mechanisms, and so forth which can be utilized to adjust and tailor the functionality provided herein. Thus, the user may shake a device, twisted, or move it to a certain location, which can cause a change in what functionality is presented and available through deeper button presses. For example, a remote control used in living room may provide a certain type of functionality for deeper button presses that might differ from the type of functionality available when the remote control is used in a kitchen or a bedroom. The user could set up a profile which conforms to their viewing practices. Perhaps the user typically watches the news in the kitchen but likes watching movies in the family room. The functionality could be predisposed or in a default mode such that the news genre is already set when the remote is in the kitchen but adjusts to movie control in the family room.

Additionally, the functionality that is available through the deeper level of button presses can also adjust based on a time of day, social media data which may be available, current news or other current events, and so forth. For example, if the system can receive a data feed indicating that friends of the user have recently watched a certain movie, and the system may provide an option such that when the user is sitting down to watch a movie or the news, and provides a first level of pressure on the button, the system may provide a tailored personalized instruction that if the user presses down to a level 2 level of pressure, then a certain movie can be retrieved and watched which has been watched by three of their friends in the last week.

In another aspect, the system can include the ability of providing different users with different actions for “deeper” presses in the same context, such as changing a channel. The system can measure usage patterns to see which levels are more used from the various users. Machine learning, artificial intelligence, or other analyses can be made to adjust and arrive at an efficient correspondence to pressure level and functionality.

When such functionality changes, the system can provide a visual identification of the mode which the system is in for receiving different levels of pressure or the system could provide haptic feedback to the user about the mode. Additionally, as has been noted above, haptic feedback can be provided to the user indicating whether they have provided a press at a level 1 pressure, level 2 pressure, level 3 pressure, and so forth.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

What is claimed is:

1. A method comprising:
receiving first user input from a user, at a first level of pressure, via a button on a device, the first user input resulting in a first function being performed;
providing, based on the first user input and based on a context associated with the first user input, a first indication of a second function that would be performed if the user provided a second user input at a second level of pressure on the button;
receiving the second user input at the second level of pressure on the button;
based on receiving the second user input, performing the second function; and
presenting a second indication that the second function has been performed.

2. The method of claim 1, wherein the second level of pressure is greater than the first level of pressure.

3. The method of claim 1, wherein the second function is chosen based on one or more of a user history, a user experience, a user preference, a location of the device, social media data, time of day or current events.

4. The method of claim 1, further comprising:
based on the second function being performed, presenting a third indication that third function would be performed if the user provided a third user input at a third level of pressure on the button.

5. The method of claim 1, wherein the context comprises one or more of changing channels, pagination, volume control, recording functionality, or trick play.

6. The method of claim 1, wherein the first indication comprises one or more of a visual indication, a color based indication, an audible indication, a multimodal indication, a tactile indication, a vibration indication or a time-based indication.

7. The method of claim 1, wherein the providing of the first indication of the second function that would be performed if the user provided the second user input at the second level of pressure on the button is based on an analysis of the first user input.

8. The method of claim 7, wherein the analysis comprises an analysis of one or more of a timing of how quickly the user presses the button on a periodic basis, how long the user holds down the button, how hard the user presses the button, other user input, or motion input.

9. The method of claim 1, wherein the first user input comprises one of continuing to hold the button down from the first user input to the second user input or releasing the button between the first user input and the second user input.

10. A system comprising:
a processor;
a computer-readable storage device storing instructions which, when executed by the processor, cause the processor to perform operations comprising:
receiving first user input from a user, at a first level of pressure, via a button on a device, the first user input resulting in a first function being performed;
providing, based on the first user input and based on a context associated with the first user input, a first indication of a second function that would be performed if the user provided a second user input at a second level of pressure on the button;
receiving the second user input at the second level of pressure on the button;
based on receiving the second user input, performing the second function;
and presenting a second indication that the second function has been performed.

11. The system of claim 10, wherein the second level of pressure is greater than the first level of pressure.

12. The system of claim 10, wherein the second function is chosen based on one or more of a user history, a user experience, a user preference, a location of the device, social media data, a time of day or current events.

13. The system of claim 10, wherein the computer-readable storage device stores further instructions which, when executed by the processor, cause the processor to perform further operations comprising:
based on the second function being performed, presenting a third indication that third function would be performed if the user provided a third user input at a third level of pressure on the button.

14. The system of claim 10, wherein the context comprises one or more of changing channels, pagination, volume control, recording functionality, or trick play.

15. The system of claim 10, wherein the first indication comprises one or more of a visual indication, a color based indication, an audible indication, a multimodal indication, a tactile indication, a vibration indication or a time-based indication.

16. The system of claim 10, wherein the providing of the first indication of the second function that would be performed if the user provided the second user input at the second level of pressure on the button is based on an analysis of the first user input.

17. The system of claim 16, wherein the analysis comprises an analysis of one or more of a timing of how quickly the user presses the button on a periodic basis, how long the user holds down the button, how hard the user presses the button, other user input, or motion input.

18. The system of claim 10, wherein the first user input comprises one of continuing to hold the button down from the first user input to the second user input or releasing the button between the first user input and the second user input.

19. A computer-readable storage device storing instructions which, when executed by a processor, cause the processor to perform operations comprising:
receiving first user input from a user, at a first level of pressure, via a button on a device, the first user input resulting in a first function being performed;
providing, based on the first user input and based on a context associated with the first user input, a first indication of a second function that would be performed if the user provided a second user input at a second level of pressure on the button;
receiving the second user input at the second level of pressure on the button;
based on receiving the second user input, performing the second function; and
presenting a second indication that the second function has been performed.

20. The computer-readable storage device of claim 19, wherein the second level of pressure is greater than the first level of pressure.
